(19) United States
(12) Patent Application Publication
(10) Pub. No.: US 2008/0239632 A1
(43) Pub. Date: Oct. 2, 2008

(54) APPARATUS FOR IMPROVING THE ACCESSIBLITY OF A MOUNTED STRUCTURE

(75) Inventor: Michael J. Wayman, Waconia, MN (US)

Correspondence Address: FOGG & POWERS LLC, 10 SOUTH FIFTH STREET, SUITE 1000, MINNEAPOLIS, MN, 55402, US

(73) Assignee: ADC TELECOMMUNICATIONS, INC., Eden Prairie, MN (US)

(21) Appl. No.: 11/691,980

(22) Filed: Mar. 27, 2007

(51) Int. Cl. H02B 1/00

(52) U.S. Cl. 361/600

(57) ABSTRACT

An electronic equipment apparatus is provided. The electronic equipment apparatus includes an enclosure for holding electronic equipment. The electronic equipment apparatus also includes a hinged pivot mount, wherein the enclosure is rotatably coupled to the hinged pivot mount.

### CROSS REFERENCE To RELATED APPLICATIONS

This application is related to U.S. patent applications Ser. No. ______ (Attorney Docket No. 100.840US01) having a title of “MODULARIZED RADIO FREQUENCY BAND COMPONENTS ON REMOVABLE DOORS” (also referred to here as the “'840 Application”), Ser. No. ______ (Attorney Docket No. 100.834US01) having a title of “CLAMSHELL CHASSIS ASSEMBLY” (also referred to here as the “'834 Application”), and Ser. No. ______ (Attorney Docket No. 100.-8315US01) having a title of “A MULTI-FUNCTIONAL HINGE” (also referred to here as the “831 Application”) which are each filed on even date herewith. The '840, '834, and '831 Applications are hereby incorporated herein by reference.

### BACKGROUND

For many years outdoor electronic enclosures have been mounted on utility poles high above the ground. To access the enclosure for repairs or maintenance a serviceperson is usually lifted in the boom of a boom truck to the height of the enclosure. From the elevated boom the serviceperson can generally only access what is within an arm's reach, because a boom, once elevated, has minimal if any capability for lateral movement. If, for example, the enclosure has an access door on each of its four sides, the boom may provide the operator with access to at most three sides of the enclosure. The fourth side has limited access, because it is mounted to the pole and is generally on the side of enclosure opposite of the boom.

Typically the only means of access to components located on or near this fourth side of the enclosure is by completely removing the enclosure from the pole, or by opening one of the other access doors and reaching through the enclosure. Both of these options present problems. For example, the enclosures are often large, heavy, and securely mounted to the pole, all which make removing the enclosure no small task. The enclosure is typically connected to some type of power source, requiring trained technicians to disconnect. Also, if the enclosure provides some type of service, such as telecommunications coverage, power distribution, security or monitoring, removing the enclosure can have a negative impact on the system. Additionally, enclosures generally make efficient use of internal space, resulting in many cables running about. This makes it difficult or impossible to reach through the enclosure.

For the reasons stated above, and for other reasons stated below which will become apparent to those skilled in the art upon reading and understanding the present specification, there is a need in the art for a mechanism that provides easy access to the pole side of a mounted enclosure.

### SUMMARY

The above-mentioned problems of current systems are addressed by embodiments of the present invention and will be understood by reading and studying the following specification. The following summary is made by way of example and not by way of limitation. It is merely provided to aid the reader in understanding some of the aspects of the invention. In one embodiment, an electronic equipment apparatus is disclosed. The electronic equipment apparatus includes an enclosure for holding electronic equipment. The electronic equipment apparatus also includes a hinged pivot mount, wherein the enclosure is rotatably coupled to the hinged pivot mount.

### BRIEF DESCRIPTION OF THE DRAWINGS

The present invention can be more easily understood, and further advantages and uses thereof are more readily apparent, when considered in view of the detailed description and the following figures in which:

FIG. 1 is a perspective view of one embodiment of a pivoting enclosure system in an open position;

FIG. 2 is another perspective view of the pivoting enclosure system of FIG. 1 in a closed position;

FIG. 3A is a front view of a pivoting bracket for use in a system similar to FIG. 1;

FIG. 3B is a side view of a pivoting bracket for use in a system similar to FIG. 1;

FIG. 3C is a back view of a pivoting bracket for use in a system similar to FIG. 1; and

FIG. 3D is a top view of a pivoting bracket for use in a system similar to Figure

In accordance with common practice, the various described features are not drawn to scale but are drawn to emphasize specific features relevant to the present invention. Like reference characters denote like elements throughout the Figures and text.

### DETAILED DESCRIPTION

In the following detailed description, reference is made to the accompanying drawings that form a part hereof, and in which is shown by way of illustration specific illustrative embodiments in which the method and system may be practiced. These embodiments are described in sufficient detail to enable those skilled in the art to practice the invention, and it is to be understood that other embodiments may be utilized and that logical, mechanical and electrical changes may be made without departing from the spirit and scope of the present invention. The following detailed description is, therefore, not to be taken in a limiting sense.

Embodiments of the present invention provide for a system for mounting a telecommunications enclosure, or similar enclosure containing electronic devices, to a mounting surface, and enabling the enclosure to pivot relative to the mounting surface.

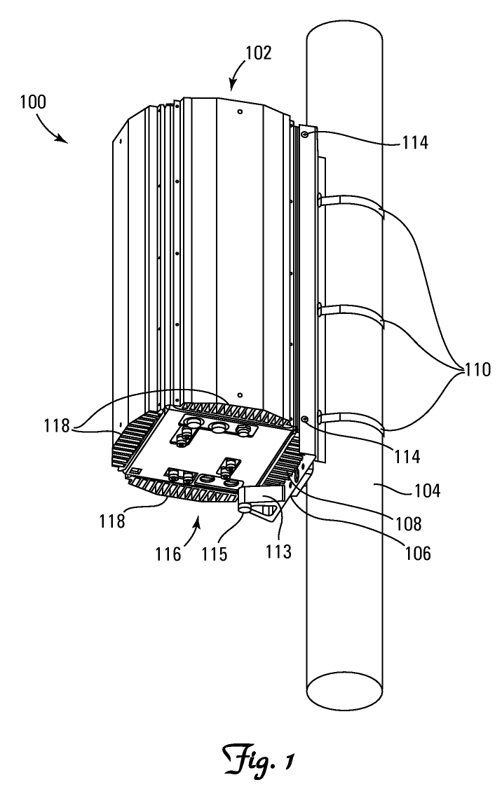

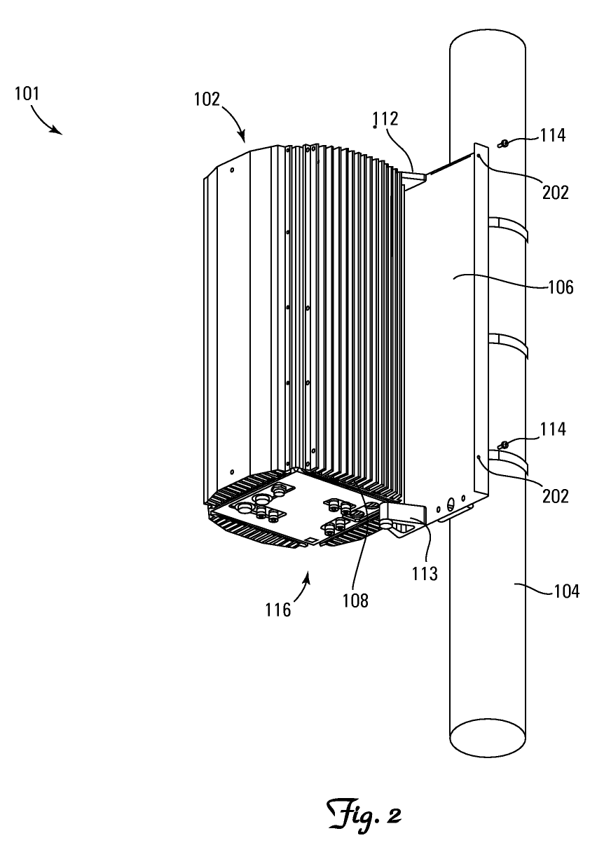

With reference now to the figures, FIGS. 1 and 2 illustrate perspective views, shown generally at 100 and 101 respectively, of a pivot mount 106 (pivot bracket) that improves the accessibility of an enclosure 102 and enables enclosure 102 to be mounted to a utility pole 104. Pivot mount 106 provides secure attachment of enclosure 102 to pole 104. Notably, pivot mount 106 allows enclosure 102 to partially rotate about an axis relative to pole 104 which exposes a back side 108 (pole side) of enclosure 102. Access to pole side 108 of enclosure, enables easier upgrades and repairs for maintenance crews accessing components on or near pole side 108 of enclosure 102.

As shown in FIG. 1, enclosure 102 is a telecommunications enclosure, or more specifically, a cabinet holding a plurality of telecommunication devices. In alternate embodiments, enclosure 102 could be any enclosure containing any type of devices, which is mounted to an upright structure and with which it is desirable to have access to the pole side of the enclosure. As it is used here, enclosure 102 includes devices mounted internally, externally, or both. Although FIG. 1 shows enclosure 102 mounted to a utility pole 104, other mounting surfaces are contemplated as within the scope of the present invention. For example, alternate embodiments include, but are not limited to, a light pole, a tree, a side of a building, or any other upright structure.

Pivot mount 106 includes a first hinge 112 and a second hinge 113 for coupling enclosure 102 to pole 104. Hinges 112, 113 provide the ability to pivot enclosure 102 relative to pole 104. First hinge 112 is located at the top of enclosure 102 and second hinge 113 is located at the bottom of enclosure 102. In this embodiment, enclosure 102 has an aperture in both the top and bottom for connecting enclosure 102 to hinges 112, 113. One pivot bolt 115 for each hinge 112, 113 is used to connect enclosure 102 to each hinge 112, 113. Each pivot bolt 115 extends through an aperture (not shown) in each hinge 112, 113 and into the aperture in enclosure 102. In this embodiment, the apertures in enclosure 102 are threaded and bolts 115 screw into the threaded apertures. Bolts 115 are solidly connected to enclosure 102, and thus rotate with enclosure 102 as enclosure 102 is pivoted. As enclosure 102 is pivoted, bolts 115 rotationally slide within the apertures of hinges 112, 113.

As known to those skilled in the art, although in this embodiment, an aperture and a bolt 115 are used to connect enclosure 102 to hinges 112, 113, other mechanisms for connecting enclosure 102 to hinges 112, 113 are contemplated as within the scope of this invention. For example, a screw or a pin could be used to connect hinges 112, 113 to enclosure 102. Additionally, although for illustration purposes two hinges (e.g. 112, 113) are used to connect to enclosure 102, the present invention is not intended to be so limited. Notably, a single hinge, or more than two hinges could be used. Also, in other embodiments, a different type of hinge is used. For example, in one embodiment, a single hinge of the type common in household door applications could be used. In this embodiment, one component of the hinge is connected to the side of enclosure 102, and the other component of the hinge is connected to pivot mount 106. In this embodiment, both components are aligned and a pin is placed through the components. Alternatively, any other type of hinge could be used as known to those skilled in the art.

As shown, hinges 112, 113 define a vertical pivoting axis for enclosure 102 through each of the apertures within hinges 112, 113. In this embodiment, enclosure 102 “opens” to the left by pivoting from the position shown in FIG. 1 to the position shown in FIG. 2. The vertical axis provided by hinges 112, 113 is located off-centered in enclosure 102. This positioning of hinges 112, 113 enables full exposure of pole side 108 when enclosure 102 is pivoted to the open position as shown in FIG. 2.

In another embodiment, hinges 112, 113 are disposed to provide a horizontal pivot axis. In this alternative embodiment, hinges 112, 113 are connected to opposite lateral sides of enclosure 102, and enclosure 102 opens either upwards or downwards depending on the point(s) of connection between hinges 112, 113 and enclosure 102. In still another alternative embodiment, hinges 112, 113 are disposed to form a vertical pivot axis as in FIG. 1; however, hinges 112, 113 are connected to enclosure 102 near the center of the top and bottom of enclosure 102. In this alternative embodiment, enclosure 102 can freely rotate 360 degrees to the degree restricted only by cables other obstacles hindering such rotation.

In the illustrative embodiment of FIG. 1, enclosure 102 has a plurality of electrical connectors shown generally at 116. Electrical connectors 116 are used to connect cables (e.g. fiber optic cables, coaxial cables, power cables, etc.) to enclosure 102. In this embodiment, connectors 116 are positioned near the vertical pivot axis to minimize the translational distance of travel when enclosure 102 is pivoted. This minimizes the strain on the cables and reduces the amount of slack required when connecting the cables.

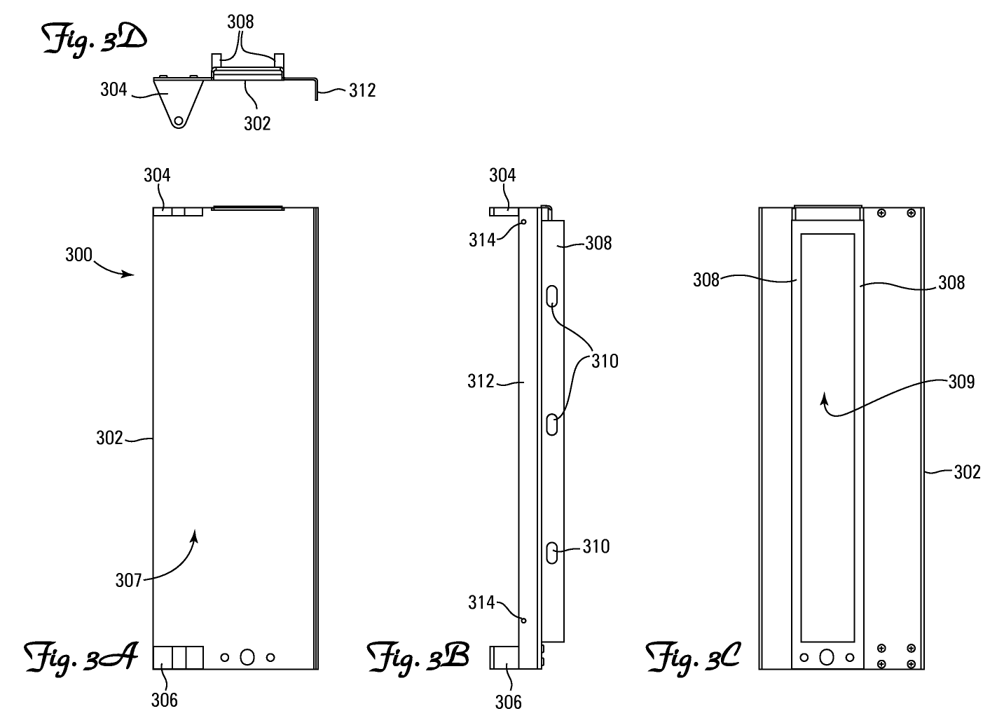

FIGS. 3A, 3B, 3C, and 3D illustrate front, side, back, and top views respectively of one embodiment of a pivot mount 300 which is similar to pivot mount 106 shown in FIGS. 1 and 2. Pivot mount 300 has a base 302, a first hinge 304, and a second hinge 306. Base 302 has an enclosure face 307 (shown in FIG. 3A) which is on the side of pivot mount 300 in which the enclosure is adjacent when the enclosure is in the closed position. Enclosure face 307 has a design and shape that fits the pole side 108 of enclosure 102. In this embodiment, enclosure face 307 of base 302 is flat and planar. The present invention, however, is not intended to be limited to a flat and planar enclosure face 307. For example, in other embodiment, an enclosure has a rounded side adjacent to enclosure face 307, and enclosure face 307 of base 302 is similarly rounded to match with the side of the enclosure.

Base 302 also has a pole face 309 shown in FIG. 3C. Pole face 309 of enclosure 3C has a design and shape that fits onto pole 104. In this embodiment, pole face 309 of base 302 has a stabilizer 308 (shown in FIGS. 3B, 3C, and 3D) made up of two rails. Each rail of stabilizer 308 extends vertically on base 302 of pivot mount 300 and is spaced apart from the other rail. This allows pivot mount 300 to mount evenly and securely upon pole 104. When pivot mount 300 is mounted to pole 104, the rails extend parallel with pole 104 and the curvature of pole 104 is straddled between the two rails. Each rail has a plurality of apertures 310 through which a band clamp 110 (shown in FIGS. 1 and 2) is inserted. When pivot mount 300 is mounted to pole 104, each band clamp 120 extends around pole 104 and through one of the apertures 310 of pivot mount 300. To secure pivot mount 300 to pole 104, each band clamp 110 is tightened around pole 104. This causes stabilizer 308 to place force against pole 104, thus holding pivot mount 300 to pole 104. Each band clamp 110 is of sufficient size and strength, such the weight of enclosure 102 and pivot mount 300 are supported.

FIG. 3B shows a side of pivot mount 300 opposite of hinges 304, 306 having a lip 312. Lip 312 of base 302 is used to hold enclosure 102 in a closed position (as shown in FIG. 2) when pole side 108 of enclosure 102 is not being accessed. Lip 312 has two apertures 314 which each accept a screw 114 (shown in FIGS. 1 and 2). When enclosure is closed, screws 114 are screwed through apertures 310 and are tightened, applying pressure to enclosure 102 and preventing enclosure 102 from unintentionally pivoting out of the closed position. Although in this illustrative embodiment, lip 312 and screws 114 are used as a fastener to hold enclosure 102 in the closed position, the present invention is not intended to be so limited. In other embodiments, enclosure 102 is held in place with a different fastener. For example, enclosure 102 may have apertures into which screws 114 could be inserted to hold enclosure 102 in place, or a pin, strap, mechanical latch, or other mechanism that does or does not use apertures 314 could be used to hold enclosure 102 in place.

Referring back to FIGS. 1 and 2, to easily access pole side 108 of enclosure 102, enclosure 102 is pivoted (opened) to 90 degrees as shown in FIG. 2. To allow enclosure 102 to pivot from the closed position, screws 114 are removed from apertures 202 in pivot mount 106. Alternatively, instead of screws 114, a captive fastener could be used to hold the enclosure in the closed position. In this case the captive fastener would be loosed to disengage from pole side 108, yet still be held captive within pivot mount 106. As shown in FIG. 2, with screws 114 removed, enclosure 102 can pivot freely by manual rotation to an open position. As shown in FIG. 2, enclosure 102 is opened to approximately 90 degrees from the fully closed position. In other embodiments, however, hinges 112, 113 could be positioned in other locations to allow pivoting of enclosure 102 of differing degrees as desired for the particular application.

To protect pole side 108 from the natural elements, and prevent access to pole side 108, enclosure 102 is pivoted to the closed position. Screws 114 are then screwed through apertures 202 in pivot mount and tightened against enclosure. Although pole side 108 is difficult to access in the closed position, in this embodiment, the other three sides 118 of enclosure 102 are still accessible. For additional security, a mechanical cylinder having a proprietary heat fastener could replace one or both of screws 114. In other embodiments, an external feature could be included to allow for an external padlock to be used.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. An electronic equipment apparatus, the apparatus comprising:
an enclosure for holding electronic equipment; and
a hinged pivot mount;
wherein the enclosure is rotatably coupled to the hinged pivot mount.

2. The apparatus of claim 1, wherein the hinged pivot mount further comprises:
a base configured to mount to a mounting surface; and
at least one hinge connected to the base, the hinge configured to rotatably connect to the enclosure to allow the enclosure to pivot relative to the mounting surface.

3. The apparatus of claim 1, wherein the hinged pivot mount is secured to a mounting surface.

4. The apparatus of claim 3, wherein the hinged pivot mount is secured to the mounting surface with at least one band clamp.

5. The apparatus of claim 4, wherein the hinged pivot mount further comprises:
a stabilizer having two vertical rails, each rail having at least one aperture through which the at least one band clamp is inserted.

6. The apparatus of claim 1, further comprising:
a fastener configured to secure the enclosure in a closed position.

7. The apparatus of claim 6, wherein the fastener further comprises:
a lip having at least one aperture configured to accept a screw, the aperture positioned such that the screw when inserted through the aperture will contact the enclosure and hold the enclosure in a closed position.

8. The apparatus of claim 1, wherein the hinged pivot mount is configured to mount to a pole.

9. The apparatus of claim 1, wherein the hinged pivot mount is configured to accommodate a side of the enclosure that is adjacent to the base when the electronic enclosure is in a closed position.

10. The apparatus of claim 1, wherein a pivot axis of the hinge is off-centered of the enclosure.

11. A pivot mount for mounting an electronics enclosure to a mounting surface, the pivot mount comprising:
a base configured to mount to a mounting surface; and
at least one hinge connected to the base, the hinge configured to rotatably connect to an electronics enclosure to allow the electronics enclosure to pivot relative to the mounting surface.

12. The pivot mount of claim 11, further comprising:
a fastener configured to secure the electronics enclosure in a closed position.

13. The pivot mount of claim 12, wherein the fastener further comprises:
a lip having at least one aperture configured to accept a screw, the aperture positioned such that the screw when inserted through the aperture will contact the electronics enclosure and hold the electronics enclosure in a closed position.

14. The pivot mount of claim 11, wherein the base of the pivot mount is configured to mount to a pole.

15. The pivot mount of claim 11, wherein the base mounts to the mounting surface with at least one band clamp.

16. The pivot mount of claim 15, wherein the base of the pivot mount further comprises:
a stabilizer having two vertical rails, each rail having at least one aperture through which the at least one band clamp is inserted.

17. The pivot mount of claim 11, wherein the base is configured to accommodate a side of the electronic enclosure that is adjacent to the base when the electronic enclosure is in a closed position.

18. The pivot mount of claim 11, wherein a pivot axis of the hinge is off-centered of the electronics enclosure.

19. A system for securing electronic equipment to a mounting surface, the system comprising:
a means for housing electronic equipment; and
a means for mounting the means for housing the electronic equipment;
wherein the means for housing is rotatably coupled to the means for mounting.

20. The system of claim 19, wherein the means for mounting includes at least one clamp.

21. The system of claim 20, wherein the means for mounting has at least one stabilizer and the at least one clamp extends through an aperture in the stabilizer.

22. The system of claim 19, wherein the means for mounting includes a means for securing the enclosure in a closed position.
